(19) United States
(12) Patent Application Publication
(10) Pub. No.: US 2007/0234981 A1
(43) Pub. Date: Oct. 11, 2007

(54) V-engine with auxiliary shafts

(76) Inventors: Hans-Rudolf Jenni, Grasswill (CH); Eberhard Wizgall, Illingen (DE)

Correspondence Address: SHLESINGER, ARKWRIGHT & GARVEY LLP;ESTABLISHED 1950, SUITE 600, 1420 KING STREET, ALEXANDRIA, VA, 22314, US

(21) Appl. No.: 11/716,665

(22) Filed: Mar. 12, 2007

(30) Foreign Application Priority Data
Mar. 17, 2006 (DE) 10 2006 013 941.0

(51) Int. Cl. F02B 75/22

(52) U.S. Cl. 123/54.4

(57) ABSTRACT

The present invention relates to a V-engine having a crank shaft 20, two banks of cylinders, each comprising at least one cylinder, having a cylinder head in which at least one camshaft 100,102 is provided, and two auxiliary shafts 30,32 arranged substantially laterally of the crank shaft. Moreover, a force-transmitting endless element 40 is also provided, inter alia, which connects the crankshaft 20 to the auxiliary shafts 30,32 and a water pump 60. Additional endless elements 50,52 connect the auxiliary shafts 30,32 to one of the camshafts 100,102.

The present invention relates to a V-engine with auxiliary shafts which is intended particularly for use as an outboard motor on an aquatic vehicle.

Outboard motors for driving boats are generally known. They are typically attached to the stern of the boat with clamping screws and thereby differ from inboard motors, which are installed inside the boat. It is desirable that outboard motors should have a high performance, low weight and the most dynamic driving characteristics possible, i.e. the motor should react immediately to control instructions. For this reason outboard motors for aquatic vehicles are conventionally designed as petro-burning 4-stroke or 2-stroke Otto engines. The proportion of diesel outboard motors is less than one percent. One reason for this is the higher weight of the diesel motors compared with petrol engines of the same power. The higher weight usually results from the larger stroke volume and more complex materials. In addition, diesel motors often have less responsive driving characteristics than petrol engines, which makes them unsuitable for use a outboard motors.

On the other hand, there are factors which make the use of diesel motors appear desirable. A diesel motor is distinguished from petrol engines by higher efficiency and a lower fuel consumption. In addition, the emission thresholds of the Lake Constance gas emissions Stage 2, for example, could be met by a diesel outboard motor without any after-treatment of the exhaust gas.

Moreover, because of current fire regulations for large yachts, separate petrol stores on board are undesirable. As many large yachts carry a supply boat with an outboard motor, it would be advantageous if the outboard motor could be run on diesel. There would then be no need to carry additional petro supplies, and the outboard motors could run on the same diesel fuel as the main drive of the yacht. In addition, the fuel costs for diesel are lower than for normal petrol.

Thus, the crucial factor for using a diesel motor as an outboard motor on aquatic vehicles is not only that it should have the most dynamic driving characteristics possible but that it should have high power with low weight. In order to achieve the lowest possible weight and make the engine usable as an outboard motor the smallest possible construction is preferred.

According to the invention, therefore, a V-engine is provided having a crankshaft, two banks of cylinders each comprising at least one cylinder, having a cylinder head in which is provided at least one camshaft, and two auxiliary shafts arranged substantially to the side of the crankshaft.

The provision of two auxiliary shafts to the side of the crankshaft means that there is no need for an additional auxiliary shaft inside the V of the engine, as is typically the case in V-engines of the prior art. As a result it is possible to reduce the V angle, thereby reducing the overall width of the engine and achieving a compact structure for the engine.

In one embodiment of the invention the crankshaft is connected to at least one of the auxiliary shafts by means of at least one power-transmitting endless element.

Preferably, the crankshaft is connected to both auxiliary shafts by means of a power-transmitting endless element

According to a preferred further feature of the invention the auxiliary shafts are connected to the at least one camshaft of one of the cylinder heads by means of further power-transmitting endless elements. The auxiliary shafts thus serve to transmit power from the crankshaft to the camshaft and are each connected by means of power-transmitting endless element to one of the camshafts and together are connected to the crankshaft by means of another power-transmitting endless element.

In a preferred embodiment of the invention the V-engine further comprises a crankcase and a bed plate which are joined together along a junction plane, the crankshaft and the two auxiliary shafts being arranged in the junction plane.

Preferably the crankshaft is arranged in the plane of symmetry of the V formed by the cylinders and between the auxiliary shafts.

Thus, an auxiliary shaft is provided on each side of the crankshaft and drives the camshaft located on the corresponding same side. The arrangement of the crankshaft and the auxiliary shaft in the junction plane between the bed plates and crankcase means that the auxiliary shafts can be mounted simply by placing the auxiliary shafts in the bed plate, as with the crankshaft. The mounting lanes needed for mounting the auxiliary shafts can be formed during the manufacture of the bed plate and crankcase with the same span as for the mounting lane of the crankshaft mounting. Thus, by arranging the two auxiliary shafts to the side of the crankshaft instead of below the crankshaft the vertical space required for the engine is also reduced. Thus a reduction in the dimensions of the motor is achieved not only in the width ways direction but also in the direction of height. Consequently the V-engine according to the invention is substantially more compact than comparable engines in the prior art and has a substantially lower weight.

Preferably, each bank of cylinders comprises an even number of cylinders. Preferably each bank of cylinders comprises two cylinders. This results in a V4 engine.

In one embodiment of the invention the power-transmitting endless element connecting the crankshaft to at least one of the auxiliary shafts may be in the form of a chain which engages in sprockets formed on the crankshaft and on the auxiliary shaft.

According to another embodiment the power-transmitting endless element connecting the crankshaft to at least one of the auxiliary shafts may be constructed as a belt.

In one embodiment of the invention the power transmitting endless elements connecting the two auxiliary shafts to at least one camshaft of a cylinder head are formed as a chain which engages in sprockets formed on the camshaft and on the auxiliary shaft.

In another embodiment of the invention the power transmitting endless elements connecting the two auxiliary shafts to the at least one camshaft of a cylinder head are each constructed as a belt.

In a preferred embodiment of the invention the power transmitting endless element connecting the crankshafts to the two auxiliary shafts is additionally connected to a water pump in order to drive it.

According to a preferred feature of the invention, the power transmitting endless elements connecting one of the auxiliary shafts to the at least one camshaft of a corresponding cylinder head are arranged such that they are connected to the camshaft between the two middle cylinders of a bank of cylinders.

In one embodiment of the invention as additional power transmitting endless element connected to at least one of the auxiliary shafts may be provided, by means of which at least one unit is driven.

In a preferred embodiment of the invention at least one unit is provided which is driven directly by one of the auxiliary shafts.

Preferably the at least one unit is arranged inside the motor. Because of the direct drive and the arrangement of the unit inside the motor, it is impossible for any leaks from pressurised systems to the outside to occur.

Preferably the at least one unit is an oil pump.

In a preferred embodiment of the invention the gear ratio between the crank shaft and the auxiliary shafts is selected such that the auxiliary shafts provide a mass equalization for the movement of the crankshaft and the cylinders.

Preferably, the auxiliary shafts are constructed as components that carry pressurized oil.

According to one feature, provided on the auxiliary shafts is an apparatus for phase adjustment which makes it possible to adjust the position of the at least one camshaft of a bank of cylinders relative to the auxiliary shaft connected to this camshaft.

Preferably, the V-engine according to the invention is in the form of a diesel engine. Moreover, the V-engine according to the invention is constructed, for example, as a four stroke engine.

In a preferred embodiment the V-engine of the present invention compresses the air supplied to the cylinders by means of an exhaust gas turbocharger.

Preferably, the V-engine according to the invention is provided as the drive for an aquatic vehicle. In a preferred embodiment of the invention the V-engine according to the invention is provided as the outboard motor of an aquatic vehicle.

According to a preferred further feature of the invention the crankshaft is positioned vertically in the installed position.

Preferably, the two cylinder heads are identical components. The cylinder heads are thus configured symmetrically such that they can be used on either of the two banks of cylinders. The symmetrical configuration of the cylinder heads is made possible by the fact that the connection of the auxiliary shafts to the corresponding camshafts takes place between the two middle cylinders of a bank of cylinders on the at least one camshaft. Accordingly, all the other connecting elements and connections on the cylinder heads are naturally formed symmetrically to the central plane of the engine.

Further features and embodiments of the invention will become apparent from the description and the attached drawings.

It will be understood that the features mentioned above and those to be described hereinafter can be used not only in the particular combination stated by also in other combinations or on their own without departing from the scope of the present invention.

The invention is schematically illustrated in the drawings by reference to an exemplifying embodiment and is described in more detail hereinafter with reference to the drawings.

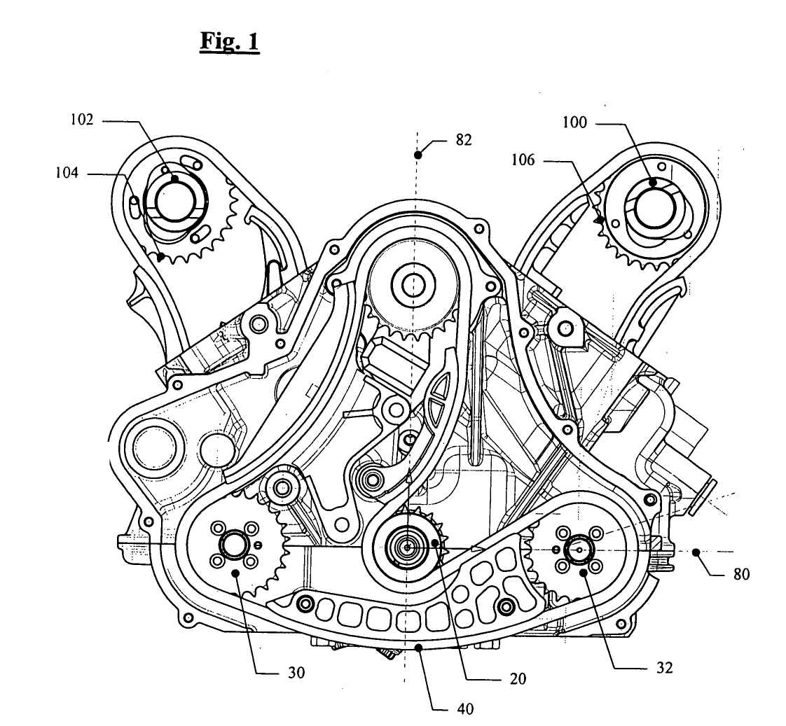

FIG. 1 shows a front view of the V-engine according to the invention in a preferred embodiment of the invention, the cylinders and cylinder heads not being shown.

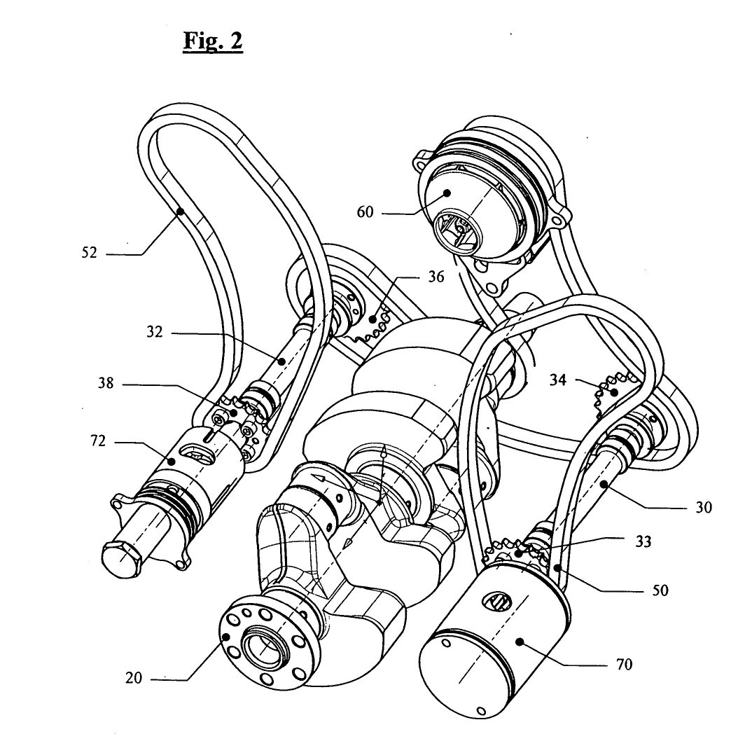

FIG. 2 shows a perspective view of the arrangement of the auxiliary shafts and the power transmitting endless elements according to the invention.

FIG. 1 shows the V-engine 10 according to the invention with two banks of cylinders each comprising two cylinders (not shown) and two camshafts 100,102, arranged in corresponding cylinder heads. According to the invention, one camshaft is provided for each cylinder head but theoretically it is also possible to provide more than one camshaft per cylinder head. The cylinders heads are not shown in FIG. 1, so as to give a view of the power transmitting endless elements 104,106.

The housing of the V-engine 10 consists of a bed plate 90 and a crank case 94. The crank case 94 and the bed plate 90 are joined together along a junction plane 80.

The Vcc formed by the cylinders is symmetrical with respect to a plane of symmetry 82. Along the line of intersection of the plane of symmetry 82 and the junction plane 80 is the axis of the crankshaft 20. An auxiliary shaft 30,32 is arranged on each side of the crankshaft 20 in the junction plane 80. A water pump 60 is arranged above the crankshaft 20 and in the plane of symmetry 82.

The crankshaft 20, the auxiliary shafts 30,32 and the water pump 60 are joined together by means of a power transmitting endless element 40. In the embodiment shown this is a chain which engages in sprockets 22,34,36,62 formed or provided on the crankshaft 20, the auxiliary shafts 30,32 and on the water pump 60.

FIG. 2 shows a perspective view of the arrangement of the auxiliary shafts 30,32 according to the invention. FIG. 2 does not show the bed plate 90 and the crankcase 94, so as to give a free view of the auxiliary shafts 30,32 and the elements attached thereto. In addition to the sprockets 34,36 formed on the auxiliary shafts 30, 32, which are provided for connecting the auxiliary shafts 30,32 to the crankshaft 20, the auxiliary shafts 30,32 each comprise further sprockets 33,38 to provide a power-transmitting connection to the camshafts 100,102. This takes place via power transmitting endless elements 50,52 which are also constructed as chains in the embodiment shown. Gear wheels 104,106 which engage in the chains 50,52 are provided on the camshafts 100,102. Thus, the camshafts 100,102 are each driven by the auxiliary shaft 30 or 32, respectively, located on their side of the crankshaft 20.

Mounted directly on the auxiliary shafts 30,32 in each case is an oil pump 70,72, driven directly by the auxiliary shafts, 30,32. Instead of an oil pump any other possible unit may also be directly connected to the auxiliary shafts 30,32. By arranging the oil pumps 70,72 directly on the auxiliary shafts 30,32 it is thus possible to arrange the oils pumps 70,72 inside the engine compartment, as a result of which, if there is a leak, no oil can escape but remains in the engine compartment. This is particularly advantageous in aquatic vehicles for reasons of environmental protection.

The sprockets 104,106 on the camshafts 100,102 are each arranged between the cylinders of a bank of cylinders. This produces a symmetrical constructions of the cylinder heads, thereby making it possible to use a cylinder head which can rotate through 180° and can be formed by flipping over. Thus, in the V-engine according to the invention, the two cylinder heads are identical components. On the one hand this gives the advantage that only one cylinder head has to be pre-fabricated, instead of two cylinder head components. Moreover, the assembly of the cylinder heads can be made substantially simpler as there is no need for any special precautions to prevent a cylinder head from being installed on the wrong side of the engine. Therefore the manufacture and assembly of the V-engine 10 is substantially more favourable than in conventional V-engines.

Thanks to the arrangement of the auxiliary shafts 30,32 to the side of the crankshaft 20, the angle of the V formed by the cylinders can be made substantially smaller than in conventional V-engines. The overall width of the engine is thereby reduced substantially. In addition, other components may be arranged in the V formed by the cylinders, e.g. the water pump 60 or an exhaust gas system (not shown).

The mounting of the auxiliary shafts 30,32 is carried out, as with the crankshaft 20, in a mounting lane which is formed in the junction plane 80, half in the bed plate 90 and half in the crankcase 94. As a mounting lane has to be machined for the crankshaft 20 in any case during the manufacture of the bed plate 90 and crankcase 94, the constructions of the mounting lanes for the auxiliary shafts 30,32 may be carried out at the same setting as that used to construct the mounting lane for the crankshaft and therefore does not require any substantially greater manufacturing effort. Similarly, the assembly of the auxiliary shafts 30,32 may take place in the same way as that of the crank shaft 20, by placing the auxiliary shafts 30,32 in the mounting lanes before the bed plate 90 is attached to the crankcase 94.

The arrangement of the auxiliary shafts 30,32 to the side of the crankshaft 20 also decrease the overall height of the V-engine 10. Because of the reduced overall dimensions of the engine, it is significantly lighter in weight than conventional V-engines and thus has a better specific weight for the same power.

The sprockets 34, 36 of the auxiliary shafts 30,32 and the sprocket 22 of the crankshaft 20 are arranged in their resulting gear ratio to one another such that the auxiliary shafts 30,32 serve to improve the mass equalisation of the crankshaft 20 and cylinders.

A phase adjuster for valve operation which adjusts the position of the camshafts 100,102 to the corresponding auxiliary shaft 30,32, is provided on each of the auxiliary shafts 30,32. In this way it is possible to set the inlet and outlet valve timings for a bank of cylinders.

By using two auxiliary shafts 30,32 in the V-engine 10 according to the invention, as described above, it is thus not only possible to drive additional units such as oil pumps 70,72 or a water pump 60, but also the overall size of the engine and hence its weight are substantially reduced. Moreover, it become possible to drive the camshafts between the two cylinders of a bank of cylinders and thus to use cylinder heads which can be constructed to flip over. Precisely as a result of the reduced overall size and lower weight the V-engine according to the invention is distinguished from the prior art by its improved specific weight and makes it possible to use a diesel-powered engine as an outboard motor on aquatic vehicles.

1. V-engine, comprising: a crankshaft (20), two banks of cylinders each having at least one cylinder, with a cylinder head in each case, in which at least one camshaft (100,102) is provided, and two auxiliary shafts (30,32) mounted substantially to the side of the crankshaft (20).

2. V-engine according to claim 1, wherein the crankshaft (20) is connected to at least one of the auxiliary shafts (30,32) by means of at least one power transmitting endless element (40).

3. V-engine according to claim 1, wherein the crankshaft 20 is connected to the two auxiliary shafts (30,32) by means of a power transmitting endless element (40).

4. V-engine according to claim 1 wherein the auxiliary shafts (30,32) are connected to the at least one camshaft (100,102) of one of the cylinder heads by means of further power transmitting endless elements (50,52).

5. V-engine according to claim 1 moreover comprising crankcase (94) and a bed plate (90), which are joined together along a junction plane (80), the crankshaft (20) and the two auxiliary shafts (30,32) being arranged in the junction plane (80).

6. V-engine according to claim 1 wherein the crankshaft (20) is arranged in a plane of symmetry (82) of the V formed by the cylinders and between the auxiliary shafts (30,32).

7. V-engine according to claim 1, wherein each bank of cylinders comprises an even number of cylinders.

8. V-engine according to claim 7, wherein each bank of cylinders comprises two cylinders.

9. V-engine according to claim 1, wherein the power transmitting endless element (40) which connects the crankshaft (20) to at least one of the auxiliary shafts (30,32) is constructed as a chain which engages in sprockets (34,36,42) formed or mounted on the crankshaft (20) and on the auxiliary shaft (30,32).

10. V-engine according to claim 1 wherein the power transmitting endless element (40) which connects the crankshaft (20) to at least one of the auxiliary shafts (30,32) is connected as a belt.

11. V-engine according to claim 9 wherein the power transmitting endless elements (50,52) which connect the two auxiliary shafts, (30,32) to the at least one camshaft (100,102) of a cylinder head are each constructed as a chain which engages in sprockets (33,38,104,106) formed or mounted on the auxiliary shaft (30,32).

12. V-engine according to claim 1, wherein the power transmitting endless elements (50,52) that connect the two auxiliary shafts (30,32) to the at least one camshaft (100,102) of a cylinder head are each constructed as a belt.

13. V-engine according to claim 3, wherein the power transmitting endless element (40) that connects the crankshaft (20) to the two auxiliary shafts (30,32) is additionally connected to a water pump (60) in order to drive it.

14. V-engine according to claim 4, wherein the power transmitting endless elements (50,52) that connect in each case one of the auxiliary shafts (30,32) to the at least one camshaft (100,102) of a corresponding cylinder head are arranged such that they are connected to the camshaft (100,102) between the two central cylinders of a bank of cylinders.

15. V-engine according to claim 1, wherein at least one additional power transmitting endless element connected to at least one of the auxiliary shafts (30,32) is provided, by means of which at least one unit (70,72) is driven.

16. V-engine according to claim 1, wherein at least one unit (70,72) is provided which is driven directly by one of the auxiliary shafts (30,32).

17. V-engine according to claim 15, wherein the at least one unit (70,72) is arranged inside the engine.

18. V-engine according to claim 15, wherein the at least one unit (70,72) is an oil pump.

19. V-engine according to claim 1, wherein the gear ration between the crankshaft (20) and the auxiliary shafts (30,32) is such that the auxiliary shafts (30,32) provide a mass equalization for the movement of the crankshaft (20) and the cylinders.

20. V-engine according to claim 1, wherein the auxiliary shafts (30,32) are constructed as components that carry pressurized oil.

21. V-engine according to claim 4, wherein there is provided on the auxiliary shafts (30,32) a device for phase adjustment which makes it possible to adjust the position of the at least one camshaft (100,102) of each bank of cylinders relative to the auxiliary shaft (30,32) connected to this camshaft (100,102).

22. V-engine according to claim 1 which is constructed as a diesel engine.

23. V-engine according to claim 1 which is constructed as a four/stroke engine.

24. V-engine according to claim 1 which compresses the air supplied to the cylinders by means of an exhaust gas turbocharger.

25. V-engine according to claim 1 which is provided as the drive for an aquatic vehicle.

26. V-engine according to claim 1, which is provided as an outboard motor for an aquatic vehicle.

27. V-engine according to claim 1 wherein the crankshaft (20) is vertically positioned in the installed state.

28. V-engine according to claim 1, wherein the two cylinder heads are identical components.
